(19) United States
(12) Patent Application Publication
(10) Pub. No.: US 2020/0166600 A1
(43) Pub. Date: May 28, 2020

(54) APPARATUS AND METHOD OF DETECTING MOVEMENT OF DETECTION PLATFORMS

(71) Applicant: THE BOEING COMPANY, Chicago, IL (US)

(72) Inventors: Michael Dominic McInnis, Port Orchard, WA (US); Payal Shah, Bellevue, WA (US); Navpreet Singh, Lynnwood, WA (US); Donald Eldon Dillenburg, Issaquah, WA (US)

(73) Assignee: THE BOEING COMPANY

(21) Appl. No.: 16/203,370

(22) Filed: Nov. 28, 2018

(51) Int. Cl. G01S 5/02; G01S 5/14

(52) U.S. Cl. CPC G01S 5/0221; G01S 5/0226; G01S 5/14

(57) ABSTRACT

A system includes a memory configured to store instructions and a processor that is coupled to the memory. The processor is configured to determine, based on data received from one or more of a reference tag or a positioning sensor tag, a change in a first orientation or position of a portal system platform. The processor is further configured to determine, based on detection data, a second orientation or position of a wireless identification (ID) tag or a change in the second orientation or position. The processor is further configured to determine whether the second orientation or position is valid based on the received data and to perform a response action responsive to determining that the second orientation or position is invalid due to the change of the first orientation or position of the portal system platform.

### FIELD OF THE DISCLOSURE

The present disclosure is generally related to movement detection and more specifically to detecting orientation of detection platforms.

### BACKGROUND

Certain wireless systems are configured to track movement of wireless identification tags and devices. To illustrate, in a particular example, items in a warehouse may be tracked using one or more wireless identification (ID) tag reader portals. In some examples, each device includes a wireless ID tag that is readable by a wireless ID tag reader portal. One example of a wireless ID tag is a passive tag that when remotely energized by wireless energy transmitted from an active ID tag reader portal is able to track and communicate bi-directionally between the tag and reader portal system. In some implementations, a transmitter and receiver within the tag and reader portal use a passive radio frequency identification (pRFID) technology. Another illustrative example of a wireless ID tag is an active tag or environment sensing tag that includes a battery and a transmitter configured to communicate uni-directional with the wireless ID tag reader portal. In another illustrative example, an active tag and wireless ID tag reader portal both are capable of transmitting and receiving communications bi-directionally with each other for tracking purposes (e.g., using an ultra-wideband (UWB) technology).

In some cases, the wireless ID tag reader portal system platforms can be bumped or moved, misaligning the wireless ID tag reader portal platform orientation with other mutually interrelated system platforms (e.g., so that the wireless ID tag reader portal platform is no longer positioned effectively to communicate with or locate wireless ID tags and wireless devices in conjunction with other interrelated ID tag reader portal platforms). Misalignment of the wireless tag reader portal system platforms can reduce location tracking accuracy and performance. As an example, warehouse personnel accidentally bumping into the wireless ID tag reader portal system platform can cause the bumped wireless ID tag reader portal to misreport the wireless ID tag data, causing inaccurate location tracking of wireless ID tags.

### SUMMARY

In a particular example, a system includes a memory configured to store instructions and further includes a processor that is coupled to the memory. The processor is configured to determine, based on data received from one or more of a reference tag or a positioning sensor tag, a change in a first orientation or position of a portal system platform. The portal system platform includes one or more antennas configured to receive a wireless data signal from a wireless identification (ID) tag and further includes a reader configured to output detection data based on the received wireless data signal. The processor is further configured to determine, based on the received data, a second orientation or position of the wireless ID tag or a change in the second orientation or position. The processor is further configured to determine whether the second orientation or position is valid based on the received data and to perform a response action responsive to determining that the second orientation or position is invalid due to the change of the first orientation or position of the portal system platform.

In another illustrative example, a method of operation of a processor includes receiving, by a processor, detection data generated by a portal system platform based on a wireless data signal received from a wireless identification (ID) tag. The portal system platform includes one or more antennas to receive the wireless data signal and further includes a reader to output the detection data based on the received wireless data signal. The method further includes determining, by the processor, a change in a first orientation or position of the portal system platform based on data received from one or more of a reference tag or a positioning sensor tag. The method further includes determining, by the processor and based on the detection data, a second orientation or position of a wireless ID tag or a change in the second orientation or position. The method further includes determining, by the processor, whether the second orientation or position is valid based on the received data. The method further includes performing, by the processor, a response action responsive to determining that the second orientation or position is invalid due to the change of the first orientation or position of the portal system platform.

In another example, a computer-readable medium stores instructions executable by a processor to initiate, perform, or control operations. The operations include receiving, by the processor, detection data generated by a portal system platform based on a wireless data signal received from a wireless identification (ID) tag. The portal system platform includes one or more antennas to receive the wireless data signal and further includes a reader to output the detection data based on the received wireless data signal. The operations further include determining, by the processor, a change in a first orientation or position of the portal system platform based on data received from one or more of a reference tag or a positioning sensor tag. The operations further include determining, by the processor and based on the detection data, a second orientation or position of a wireless ID tag or a change in the second orientation or position. The operations further include determining, by the processor, whether the second orientation or position is valid based on the received data. The operations further include performing, by the processor, a response action responsive to determining that the second orientation or position is invalid due to the change of the first orientation or position of the portal system platform.

### BRIEF DESCRIPTION OF THE DRAWINGS

FIG. 1A is a diagram illustrating certain aspects of an example of a system that includes a portal system platform and a reference tag configured to generate a signal usable by a processor to detect movement of the portal system platform.

FIG. 1B is a diagram illustrating certain aspects of the system of FIG. 1A in an example in which the reference tag is an active device.

FIG. 1C is a diagram illustrating certain aspects of the system of FIG. 1A in an example in which the reference tag is a passive device.

FIG. 2 is a diagram illustrating certain aspects associated with an example of a system that includes a portal system platform and a positioning sensor tag configured to generate a signal usable to detect movement of the portal system platform.

FIG. 3A is a diagram illustrating certain aspects associated with an example of a system including a portal system platform and a reference tag and a positioning sensor tag.

FIG. 3B is a diagram illustrating certain aspects associated with an example of a change in a first orientation or position of the portal system platform of FIG. 3A.

FIG. 4A is a diagram of an example of a method of operation of the portal system platform of FIG. 1A, FIG. 1B, FIG. 2, FIG. 3A, or FIG. 3B.

FIG. 4B is a diagram of another example of a method of operation of a processor, such as a processor that is included in the portal system platform of FIG. 1A, FIG. 1B, FIG. 2, FIG. 3A, or FIG. 3B.

FIG. 5 is a block diagram illustrating aspects of an example of a computing system that is configured to execute instructions to initiate, perform, or control operations, such as operations of the method of FIG. 4A, operations of the method of FIG. 4B, or both.

### DETAILED DESCRIPTION

In a particular implementation, a portal system platform (e.g., wireless tag reader portal) is configured to track movement of wireless identification (ID) tags using wireless communication (e.g., based on trilateration). Depending on the particular implementation, the portal system platform is configured to communicate with the wireless ID tags using an active technique (e.g., an UWB technique) or using a passive technique (e.g., using an RFID technique). In some examples, the portal system platform is positioned at the entry and/or exit of a storage region of the warehouse to enable the portal system platform to track movement of the wireless ID tags (e.g., to detect movement of the wireless ID tags into or out of the storage region). In accordance with the disclosure, movement of the portal system platform is detected so that the portal system platform can be reoriented (e.g., to the “correct” orientation or position) to reduce or prevent instances of “misreading” movement of the wireless ID tags.

To detect the movement of the portal system platform, the portal system includes a reference tag configured to generate data and a reader which communicates with a location determination processor. To illustrate, in one example, the location determination processor determines location data (e.g., location coordinate information, such as x axis data, y axis data, z axis data, or other geospatial location data) associated with the reference tag. In some examples, a processor is configured to receive the location data, to analyze the location data, and to generate alerts. Depending on the particular implementation, the processor and the location determination processor can correspond to different processors, or functionalities of the processors can be implemented using a single processor.

In a first particular example, the reference tag (e.g., a stationary wireless ID or RFID device) is attached to a “fixed” location, such as a floor or other structure near the portal system platform. In a second particular example, the portal system platform includes a positioning sensor tag (e.g., one or more of an accelerometer, a tilt sensor, a compass, a pitch sensor, or another electronic positioning sensor). In a third particular example, the portal system platform includes both the reference tag and the positioning sensor tag (e.g., where the positioning sensor tag is embedded within the reference tag or within a particular component of the portal system platform).

In one example, the processor is configured to determine an indication of a first orientation or position (e.g., location and positioning) of the portal system platform, such as upon setup of the portal system platform. In a particular example, the processor determines the indication of the first orientation or position of the portal system platform upon positioning of the portal system platform in a warehouse between “zones” of the warehouse, upon power-up of the portal system platform, or both. In some implementations, to determine the indication of the first orientation or position of the portal system platform, the processor measures one or more of a received signal strength or a frequency (e.g., a blink rate) of the data received from the device. In one example, the first orientation or position of the portal system platform is determined using the positioning sensor tag (e.g., by positioning the portal system platform so that the portal system platform has zero acceleration, zero degrees of tilt, 25 degrees of downward pitch, or a particular magnetic compass bearing or azimuth, as illustrative examples).

The processor is configured to determine, based on the data from the device, a change in a first orientation or position of the portal system platform (or a portion of the portal system platform). In one example, movement of (e.g., repositioning or bumping) the portal system platform causes the portal system platform to sense a change in the data received from the device. In a particular example, moving the portal system platform away from (or nearer to) the reference tag causes the portal system platform to sense a reduced (or increased) received signal strength of the data generated by the reference tag of the device. Alternatively or in addition, in another example, movement of the portal system platform causes the positioning sensor tag to sense movement, repositioning, or acceleration of the portal system platform. In some examples, the processor is configured to periodically or occasionally “poll” the device to determine whether a change in the first orientation or position has occurred.

In response to detecting the change in the first orientation or position of the portal system platform, the processor is configured to determine that detected movement of a wireless ID tag (e.g., a change in a second orientation or position of the wireless ID tag) is unreliable or invalid (due to the change in the first orientation or position of the portal system platform) or that the portal system platform should be repositioned (e.g., by moving the portal system platform to a “correct” position). For example, by changing the first orientation or position of the portal system platform, the portal system platform can misreport equipment movement, such as by reporting the wireless ID tag as being checked in instead of being checked out (or vice versa).

In some implementations, the portal system platform includes an alert device configured to generate a local alert in response to detecting the change in the first orientation or position of the portal system platform. In one example, the portal system platform includes an optical device, such as one or more light emitting diodes (LEDs) configured to indicate one or more colors (e.g., green for valid or red for invalid, etc.) based on the first orientation or position of the portal system platform. In one example, orientation and location of the portal system platform are configured in advance using a positioning sensor tag on the portal system platform to enable one or more LEDs of the optical device to assist with an initial installation of the portal system platform.

Alternatively or in addition, in some implementations, the portal system platform is configured to send information indicating the change in the first orientation or position to a server (e.g., a data analytics server) or to another device. In a particular example, the server is configured to analyze the information to determine whether the change in the first orientation or position indicates an error and to invalidate (or flag) one or more previous data entries in response to the change. In a particular example, the server is configured to transmit an alert message (e.g., to an operations center) indicating that the portal system platform is to be repositioned (e.g., by moving the portal system platform to a previous orientation or position).

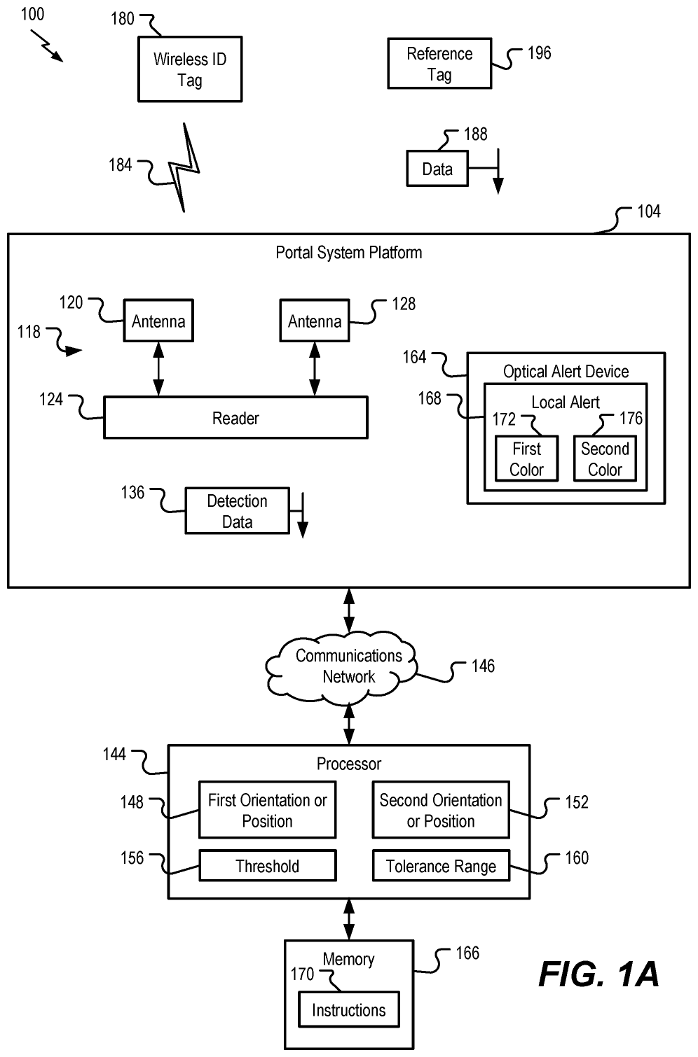

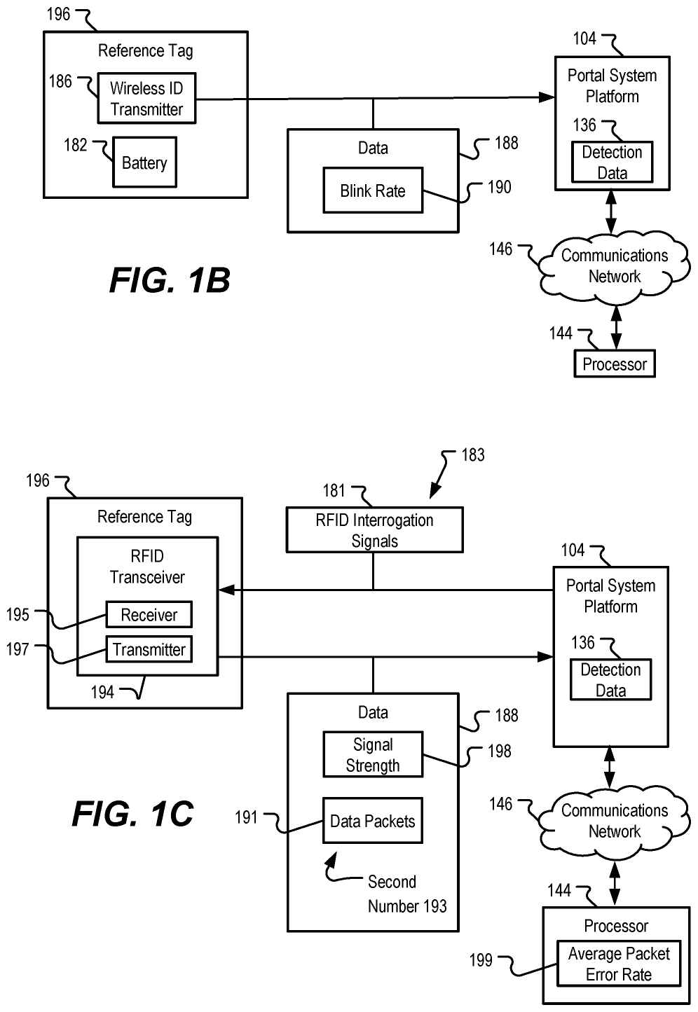

Referring to FIG. 1A, a particular illustrative example of a system is depicted and generally designated 100. The system 100 includes a portal system platform 104 (e.g., a wireless tag reader portal) configured to track location of one or more wireless identification (ID) tags, such as a wireless ID tag 180.

In a particular example, the portal system platform 104 is configured to track movement of the wireless ID tag 180 based on a wireless data signal 184 generated by the wireless ID tag 180. For example, in one implementation, the portal system platform 104 corresponds to a moveable wireless ID portal that is positioned in a particular location (e.g., a warehouse or another location). In some implementations, the portal system platform 104 is positioned between (or on a boundary between) a first zone and a second zone of the particular location to enable the portal system platform 104 to track movement of the wireless ID tag 180. To further illustrate, in a particular example, the portal system platform 104 is positioned at the entry and/or exit of a storage region of the warehouse to enable the portal system platform 104 to track movement of the wireless ID tag 180 (e.g., to detect movement of the wireless ID tag 180 into or out of the storage region).

The portal system platform 104 includes one or more antennas 118 configured to receive wireless data signals from one or more wireless ID tags, such as the wireless ID tag 180. To illustrate, in FIG. 1A, the one or more antennas 118 include an antenna 120 and an antenna 128. In some implementations, antennas of portal system platform 104 are associated with a particular antenna pattern (e.g., where each antenna provides some gain and has a specific antenna pattern of coverage). The one or more antennas 118 are configured to receive wireless data signals from one or more wireless ID tags 180, such as the wireless data signal 184 from the wireless ID tag 180.

The portal system platform 104 further includes a reader 124 coupled to the one or more antennas 118. The reader 124 is responsive to wireless data signals received by the one or more antennas 118, such as the wireless data signal 184 and data 188. To illustrate, in FIG. 1A, the reader 124 is configured to output the detection data 136 based on the data 188.

In some examples, the detection data 136 is affected by position and orientation of the portal system platform 104. To illustrate, trilateration may be performed using the detection data 136, which can depend on different arrival times of the wireless data signal 184 at the one or more antennas 118 (due to different positions of the one or more antennas 118). In this case, misalignment of the portal system platform 104 can affect operations performed based on the detection data 136.

The system 100 further includes a processor 144 in communication with the reader 124 (e.g., via a communications network 146). In the example of FIG. 1A, the processor 144 is external to the portal system platform 104. In other examples, the processor 144 can be integrated within the portal system platform 104.

The processor 144 is configured to receive the detection data 136 from the reader 124. The system 100 further includes a memory 166 coupled to the processor 144 and configured to store instructions 170 executable by the processor 144. In some implementations, the portal system platform 104 further includes an optical alert device 164 in communication with the processor 144 (e.g., via the communications network 146).

In one example, the wireless ID tag 180 includes an ultra-wideband (UWB) transmitter. In a particular example, the one or more antennas 118 are included in a UWB receiver. In some implementations, a UWB technique uses battery power, which may improve range and/or accuracy as compared to other passive techniques. In other implementations, the wireless ID tag 180 can include another type of transmitter.

In the example of FIG. 1A, the system 100 further includes a reference tag 196. The reference tag 196 is configured to generate one or more signals, such as data 188. The processor 144 is configured to determine a change in a first orientation or position 148 of the portal system platform 104 based on the data 188. In a particular example, the processor 144 is configured to receive the data 188 and to detect the change in the first orientation or position 148 based on the data 188. In some implementations, the data 188 includes a tag identification (ID) that indicates the reference tag 196.

In some implementations, the processor 144 is configured to analyze the flow of data from devices and to detect, based on the data 188, that a movement of the portal system platform 104 affects the quality of data received at the portal system platform 104 from wireless ID tags, such as the wireless ID tag 180. In some implementations, the processor 144 is configured to detect movement of the portal system platform 104 based on a degradation of received signal strength indication (RSSI) associated with the data 188, a decrease in the data transmission count average (e.g., a blink rate) associated with the data 188, or a change in sensor data received from a positioning sensor tag.

To illustrate, in a particular example, the portal system platform 104 is configured to determine an arrival time of the data 188 as received by the one or more antennas 118. For example, due to differences in positions of the one or more antennas 118, each antenna of the one or more antennas 118 receives the data 188 at a different time in some cases. In a particular example, the processor 144 is configured to determine position of the reference tag 196 using trilateration based on the arrival times. In one example, the processor 144 is configured to store data indicating the arrival times at the memory 166.

In one example, the reference tag 196 corresponds to an active device configured to generate a signal having a particular blink rate, and the processor 144 is configured to detect the change in the first orientation or position 148 of the portal system platform 104 based on a change (as measured by the processor 144) in the blink rate. A particular example of an implementation of the reference tag 196 as an active device is described further with reference to FIG. 1B.

In another example, the reference tag 196 corresponds to a passive device configured to generate a signal having a particular signal strength, and the processor 144 is configured to detect the change in the first orientation or position 148 of the portal system platform 104 based on a change (as measured by the processor 144) in the signal strength. A particular example of an implementation of the reference tag 196 as a passive device is described further with reference to FIG. 1C.

The processor 144 is configured to determine, based on the detection data 136 from the reader 124, a second orientation or position 152 of the wireless ID tag 180 (or a change in the second orientation or position 152 of the wireless ID tag 180). In one example, the one or more antennas 118 include three or more antennas, and the processor 144 is configured to determine the second orientation or position 152 (or a change in the second orientation or position 152) via trilateration based on signals received from the one or more antennas 118.

The processor 144 is configured to determine whether the second orientation or position 152 is valid based on the data 188. For example, in response to the first orientation or position 148 indicating that the portal system platform 104 has moved (e.g., based on a change in the first orientation or position 148 exceeding a threshold 156), the processor 144 is configured to determine that the second orientation or position 152 is invalid. As another example, in response to the first orientation or position 148 indicating that the portal system platform 104 has not moved (e.g., or that a change in the first orientation or position 148 is less than, or less than or equal to, the threshold 156), the processor 144 is configured to determine that the second orientation or position 152 is valid.

In some implementations, the processor 144 is configured to perform a data analytics operation to identify that a movement to the second orientation or position 152 deviates from a tolerance range 160 by more than the threshold 156. To illustrate, in one example, the processor 144 is configured to initiate a polling operation to confirm that a movement to the second orientation or position 152 deviates from the tolerance range 160.

The processor 144 is configured to perform a response action responsive to determining that the second orientation or position 152 is invalid due to a change of the first orientation or position 148. To illustrate, in some implementations, the processor 144 is configured to initiate a local alert 168 indicating whether the second orientation or position 152 is valid.

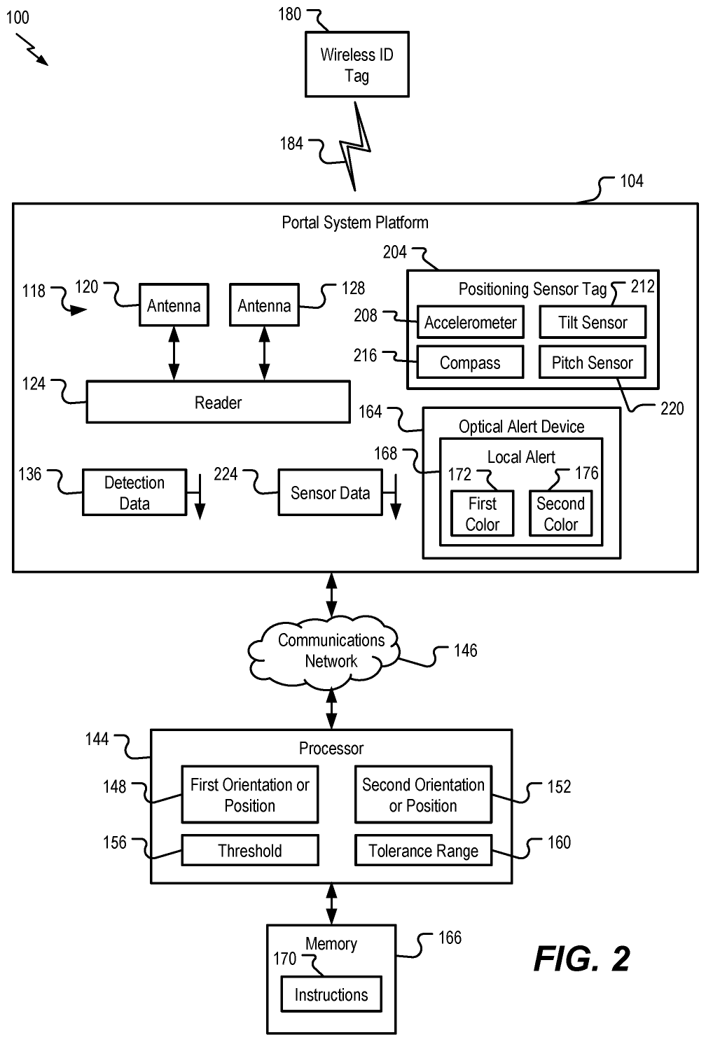

In a particular example, the optical alert device 164 is configured to generate the local alert 168. In one implementation, the optical alert device 164 includes one or more light emitting diodes (LEDs). In a particular example, the optical alert device 164 includes an LED configured to generate an optical signal (e.g., a red color) to indicate that the second orientation or position 152 is invalid due to a change of the first orientation or position 148. In another example, the optical alert device 164 includes a plurality of LEDs configured to generate a first color 172 (e.g., green) of the local alert 168 to indicate that the second orientation or position 152 is valid and to generate a second color 176 (e.g., red) of the local alert 168 to indicate that the second orientation or position 152 is invalid. As described further with reference to FIG. 2, in a particular example, the first orientation or position 148 (e.g., a physical location of the portal system platform 104) is configured in advance using a positioning sensor tag to enable one or more LEDs of the optical alert device 164 to assist with an initial installation of the portal system platform 104.

Although FIG. 1A is described with reference to a single portal system platform 104, in some implementations, multiple portal system platforms 104 are used. Alternatively or in addition, in some implementations, multiple reference tags 196 are used. To illustrate, in a particular example, multiple portal system platforms 104 communicate with the reference tag 196. In another particular example, multiple reference tags 196 communicate with the portal system platform 104.

One or more aspects described with reference to FIG. 1A can be used to detect movement of one or more portal system platforms, such as the portal system platform 104. For example, movement of the portal system platform 104 can be detected based on the data 188 generated by the reference tag 196. As a result, performance of the system 100 is improved by reducing or avoiding instances of misdetection of movement of wireless ID tags, such as the wireless ID tag 180.

FIG. 1B depicts a particular illustrative example of the reference tag 196. In FIG. 1B, the reference tag 196 is an active device. For example, in FIG. 1B, the reference tag 196 includes a battery 182 configured to supply power to one or more components of the reference tag 196.

To further illustrate, in FIG. 1B, the reference tag 196 includes a wireless ID transmitter 186. In a particular example, the wireless ID transmitter 186 is coupled to the battery 182 and is configured to receive a supply voltage from the battery 182. In some implementations, the wireless ID transmitter 186 corresponds to a UWB transmitter configured to send the data 188 using a frequency band of a UWB frequency spectrum. In another example, the wireless ID transmitter 186 is configured to operate based on a Wi-Fi communication protocol (Wi-Fi is a trademark of the Wi-Fi Alliance of Austin, Tex.), a home automation communication protocol, a personal area network (PAN) communication protocol, a ZigBee communication protocol (ZigBee is a trademark of the ZigBee Alliance of Davis, Calif.), a cellular communication protocol, another communication protocol, or a combination thereof.

In the example of FIG. 1B, the wireless ID transmitter 186 is configured to generate the data 188 based on a blink rate 190 associated with the data 188. To illustrate, in one example, the wireless ID transmitter 186 is configured to transmit the data 188 based on a particular frequency, such as 60 hertz (Hz), as a non-limiting illustrative example. In this particular example, the blink rate 190 corresponds to a transmission period or rate of once each second. In other implementations, the blink rate 190 may correspond to other transmission periods or rates.

In some implementations, the data 188 includes information associated with the reference tag 196. In one example, the data 188 indicates one or more of a tag identifier (ID) of the reference tag 196 or a battery voltage status of the battery 182.

In a particular example, the processor 144 is configured to determine the change in the first orientation or position 148 of the portal system platform 104 based on a change in the blink rate 190 or interruption of the data 188. In one example, if the portal system platform 104 is reoriented (e.g., bumped or moved), the portal system platform 104 may detect a change in the blink rate 190 (due to increased or decreased distance or disorientation between the portal system platform 104 and the wireless ID transmitter 186) or may no longer receive the data 188 (due to being out of range of the wireless ID transmitter 186). In this case, the processor 144 is configured to determine the change in the first orientation or position 148 of the portal system platform 104 based on a change in the blink rate 190 or interruption of the data 188.

One or more aspects described with reference to FIG. 1B can be used to detect movement of one or more portal system platforms, such as the portal system platform 104. As a result, performance is improved by reducing or avoiding instances of misdetection of movement of wireless ID tags, such as the wireless ID tag 180. Further, in some implementations, use of an active reference tag 196 as described with reference to FIG. 1B can improve range or accuracy associated with the data 188.

FIG. 1C depicts a particular illustrative example of the reference tag 196. In FIG. 1C, the reference tag 196 is a passive device.

To illustrate, in FIG. 1C, the reference tag 196 includes a radiofrequency identification (RFID) transceiver 194. In FIG. 1C, the RFID transceiver 194 includes a receiver 195 and a transmitter 197. In some implementations, the portal system platform 104 is configured to “wake up” the reference tag 196 by sending a signal (e.g., an interrogation signal of RFID interrogation signals 181) to the reference tag 196. In a particular example, the RFID transceiver 194 is configured to receive the signal using the receiver 195. In this example, the reference tag 196 is configured to power the transmitter 197 using the received signal to generate the data 188.

The data 188 may indicate data (e.g., identification information) associated with the reference tag 196. For example, the reference tag 196 may use the signal received from the portal system platform 104 to read the data and to transmit the data to within the data 188 (e.g., using a backscatter technique). In this example, the data 188 corresponds to a backscatter signal.

In a particular example, the transmitter 197 is configured to transmit the data 188 in response to receiving another signal from the portal system platform 104, such as in response to receiving an RFID interrogation signal from the portal system platform 104. In the example of FIG. 1C, the data 188 corresponds to a backscatter signal transmitted by the reference tag 196 (e.g., in response to an interrogation signal transmitted by the portal system platform 104). In some implementations, the transmitter 197 is configured to send the data 188 using a frequency spectrum assigned to passive RFID transmissions. In some implementations, the data 188 includes data packets 191 (e.g., where the data packets 191 are transmitted periodically). In one example, a first packet of the data packets 191 is transmitted at a first time in response to a first RFID interrogation signal of the RFID interrogation signals 181, and a second packet of the data packets 191 is transmitted at a second time after the first time in response to a second RFID interrogation signal of the RFID interrogation signals 181, etc.).

In a particular example, the processor 144 is configured to determine the change in the first orientation or position 148 based on a change in received signal strength associated with the data 188. To illustrate, in FIG. 1C, the data 188 has a signal strength 198 (e.g., a particular amplitude). In one example, if the portal system platform 104 is reoriented (e.g., bumped or moved), the portal system platform 104 the data 188 (as received by the portal system platform 104) may have a different signal strength 198 (e.g., due to increased or decreased distance or disorientation between the RFID transceiver 194 and the portal system platform 104). In this case, the processor 144 is configured to determine the change in the first orientation or position 148 of the portal system platform 104 based on a change in received signal strength of the data 188 (as received by the portal system platform 104).

In some cases, if the portal system platform 104 is re-oriented relative to the reference tag 196, the portal system platform 104 may be unable to communicate with the RFID transceiver 194 due to increased distance or disorientation between the portal system platform and the RFID transceiver 194. For example, the RFID transceiver 194 may periodically go “offline” (where the portal system platform 104 does not receive the data 188 or only occasionally receives the data 188 from the RFID transceiver 194). In this case, the processor 144 is configured to determine the change in the first orientation or position 148 of the portal system platform 104 based on a change in received signal strength of the data 188 (as received by the portal system platform 104).

In some examples, the processor 144 is configured to determine a first number 183 of the RFID interrogation signals 181 sent to the reference tag 196 and to determine a second number 193 of the data packets 191 received from the reference tag 196 at the portal system platform 104. In some examples, the processor 144 is configured to compare the first number 183 to the second number 193 and to determine a change in the first orientation or position 148 based on the first number 183 and the second number 193 (e.g., based on a determination that the second number 193 is less than the first number 183). Alternatively or in addition, in some examples, the processor 144 is configured to determine a change in the first orientation or position 148 based on a change in an average received packet error rate 199 associated with the data 188 (e.g., where the average received packet error rate 199 is based on the first number 183 and the second number 193). Further, although FIG. 1C illustrates a single portal system platform 104 and a single reference tag 196 for convenience of illustration, it is noted that some examples can use multiple portal system platforms 104, multiple reference tags 196, or both.

One or more aspects described with reference to FIG. 1C can be used to detect movement of one or more portal system platforms, such as the portal system platform 104. As a result, performance is improved by reducing or avoiding instances of misdetection of movement of wireless ID tags, such as the wireless ID tag 180. Further, in some implementations, use of a passive reference tag 196 as described with reference to FIG. 1C can reduce power consumption of the system 100 (e.g., by monitoring the signal strength of the data 188 received by the portal system platform 104 from the reference tag 196 and by adjusting the RFID interrogation signal strength transmitted toward the reference tag 196 in order to maintain received signal strength of the data 188 within pre-set parameters).

FIG. 2 depicts an example in which the portal system platform 104 includes a positioning sensor tag 204. In the example of FIG. 2, the positioning sensor tag 204 is configured to generate sensor data 224, and the processor 144 is configured to determine the change in the first orientation or position 148 of the portal system platform 104 based on the sensor data 224. In a particular example, the first orientation or position 148 (e.g., a physical location of the portal system platform 104) is configured in advance using the positioning sensor tag 204 to enable one or more LEDs of the optical alert device 164 to assist with an initial installation of the portal system platform 104.

To illustrate, in some implementations, the positioning sensor tag 204 includes (or corresponds to) one or more of an accelerometer 208, a tilt sensor 212, a compass 216, a pitch sensor 220, or another electronic positioning sensor. In one example, the accelerometer 208 is configured to generate acceleration data based on detecting acceleration of the portal system platform 104, and the sensor data 224 includes the acceleration data. Alternatively or in addition, in some implementations, the tilt sensor 212 is configured to generate tilt data based on detecting tilting of the portal system platform 104, and the sensor data 224 includes the tilt data. Alternatively or in addition, in some implementations, the compass 216 is configured to generate orientation data based on orientation of the portal system platform 104, and the sensor data 224 includes the orientation data. Alternatively or in addition, in some implementations, the pitch sensor is configured to generate pitch data based on pitch of the portal system platform 104, and the sensor data 224 includes the pitch data.

In the example of FIG. 2, the processor 144 is configured to determine the change in the first orientation or position 148 of the portal system platform 104 based on the sensor data 224. In one example, in response to detecting based on the sensor data 224 one or more of acceleration of the portal system platform 104, a change in tilt of the portal system platform 104, a change in orientation of the portal system platform 104, or a change in pitch of the portal system platform 104, the processor 144 is configured to determine the change in the first orientation or position 148 of the portal system platform 104.

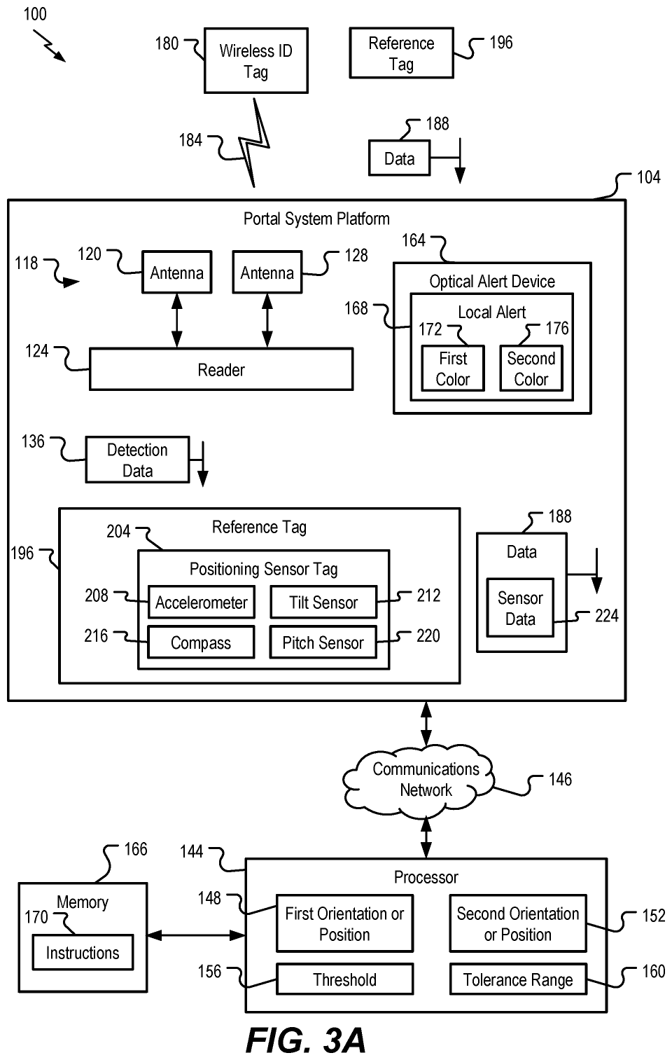

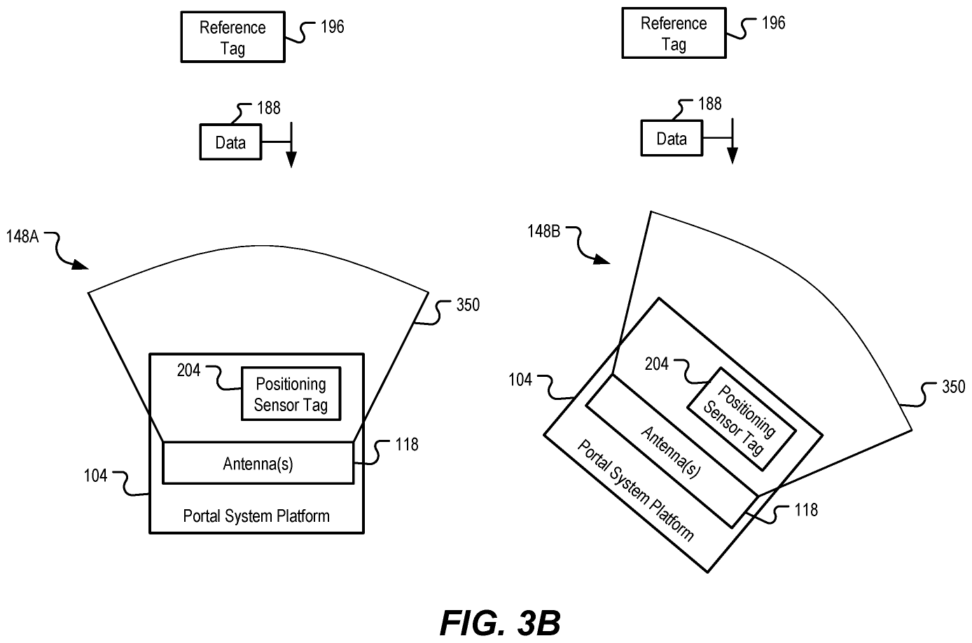

In some examples, the positioning sensor tag 204 is embedded within the portal system platform 104. To illustrate, in one example, the positioning sensor tag 204 is embedded within or attached to a structure component of the portal system platform 104, such as a beam or a post. In another example, the positioning sensor tag 204 is embedded within the reference tag 196, as described further with reference to FIGS. 3A and 3B.

One or more aspects described with reference to FIG. 2 can be used to detect movement of one or more portal system platforms, such as the portal system platform 104. As a result, performance is improved by reducing or avoiding instances of misdetection of movement of wireless ID tags, such as the wireless ID tag 180. In some implementations, use of the positioning sensor tag 204 improves accuracy of detection of movement of the portal system platform 104 as compared to other techniques.

FIG. 3A illustrates an example that includes both the reference tag 196 and the positioning sensor tag 204. In a particular example, the processor 144 is configured to compare data from the reference tag 196 and data from the positioning sensor tag 204 to detect a change in the first orientation or position 148. In one example, the processor 144 is configured to detect the change in the first orientation or position 148 in response to both data from the reference tag 196 and data from the positioning sensor tag 204 indicating a change in position of the portal system platform 104. As a result, accuracy is improved as compared to use of only the reference tag 196 or the positioning sensor tag 204.

In some implementations, the sensor data 224 is concatenated to the data 188 from the reference tag 196 (e.g., a tag ID of the reference tag 196) to form a data packet sent to the processor 144 by the portal system platform 104. In another implementation, the data 188 and the sensor data 224 are transmitted from the portal system platform 104 to the processor 144 using different wireless communications technologies (e.g., a Wi-Fi communication protocol (Wi-Fi is a trademark of the Wi-Fi Alliance of Austin, Tex.), a home automation communication protocol, a personal area network (PAN) communication protocol, a ZigBee communication protocol (ZigBee is a trademark of the ZigBee Alliance of Davis, Calif.), a cellular communication protocol, another communication protocol, or a combination thereof).

FIG. 3B is a diagram illustrating certain aspects associated with an example of a change in the first orientation or position 148 of the portal system platform 104. In FIG. 3B, the first orientation or position 148 of the portal system platform 104 is changed from 148A to 148B.

In some cases, movement of the portal system platform from 148A to 148B results in movement of the one or more antennas 118 and a change in an antenna coverage pattern 350 of the one or more antennas 118. For example, in some cases, a change of the antenna coverage pattern 350 can cause the reference tag 196 to be positioned slightly inside or outside the antenna coverage pattern 350. In some cases, a change of positioning of the reference tag 196 results in lower signal strength of the data 188 as received by the portal system platform 104, a change in a blink rate of the data 188 as received by the portal system platform 104, a change in average received packet error rate of the data 188 as received by the portal system platform 104, or a combination thereof. Alternatively or in addition, movement of the portal system platform 104 from 148A to 148B can result in a change in the sensor data 224 received from the positioning sensor tag 204 (if the positioning sensor tag 204 is attached to or embedded within the portal system platform 104).

One or more aspects described with reference to FIGS. 3A and 3B can be used to detect movement of one or more portal system platforms, such as the portal system platform 104. As a result, performance is improved by reducing or avoiding instances of misdetection of movement of wireless ID tags, such as the wireless ID tag 180. In one example, the processor 144 is configured to detect the change in the first orientation or position 148 in response to both data from the reference tag 196 and data from the positioning sensor tag 204 indicating a change in position of the portal system platform 104. As a result, accuracy is improved as compared to use of only the reference tag 196 or the positioning sensor tag 204.

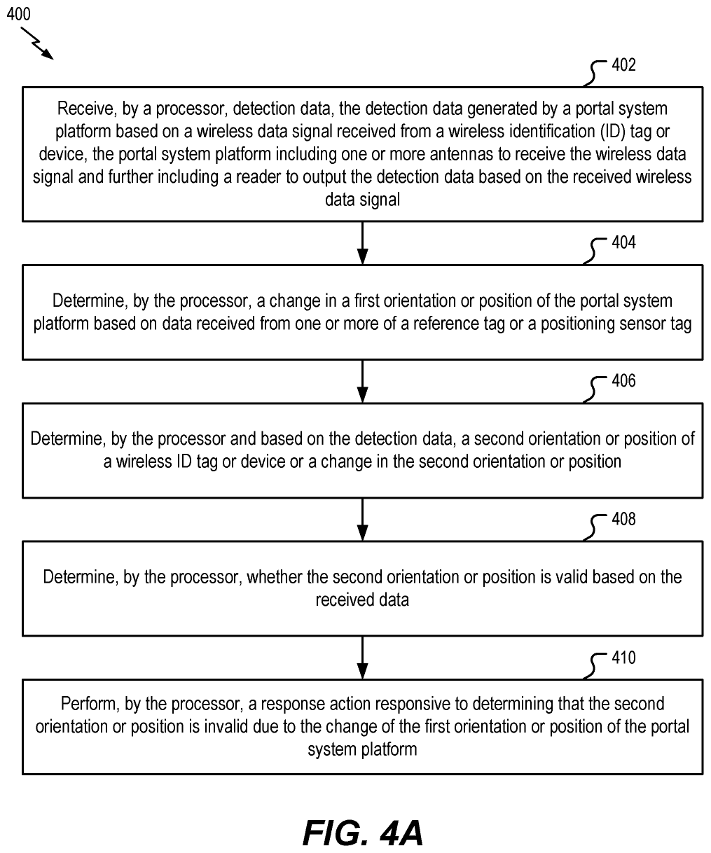

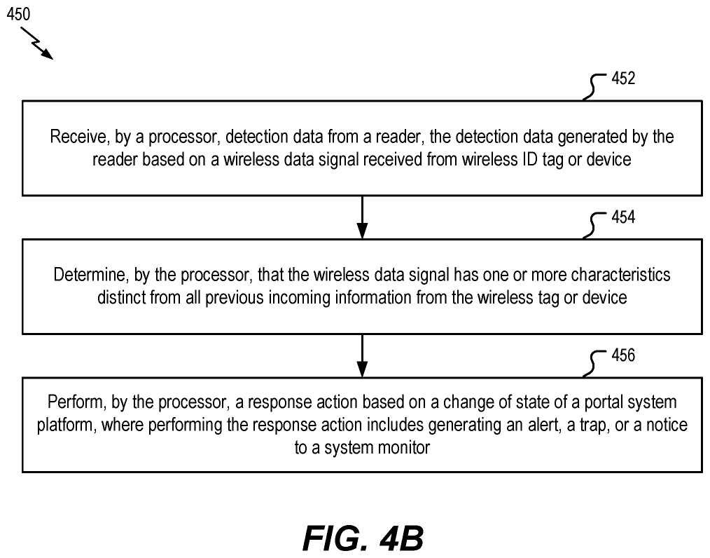

Referring to FIG. 4A, a particular example of a method of operation of a processor is depicted and generally designated 400. In a particular implementation, the method 400 is performed by the processor 144.

The method 400 includes receiving, by a processor (e.g., the processor 144), detection data (e.g., the detection data 136) generated by a portal system platform (e.g., the portal system platform 104), at 402. The detection data is generated by the portal system platform based on a wireless data signal (e.g., the wireless data signal 184) received from a wireless ID tag (e.g., the wireless ID tag 180). The portal system platform includes one or more antennas (e.g., the one or more antennas 118) to receive the wireless data signal and further includes a reader (e.g., the reader 124) to output the detection data based on the received wireless data signal.

The method 400 further includes determining, by the processor, a change in a first orientation or position (e.g., the first orientation or position 148) of the portal system platform 104 based on data (e.g., the data 188), at 404. The data is received from one or more of a reference tag (e.g., the reference tag 196) or a positioning sensor tag (e.g., the positioning sensor tag 204).

The method 400 further includes determining, by the processor and based on the detection data, a second orientation or position (e.g., the second orientation or position 152) of a wireless ID tag (e.g., the wireless ID tag 180) or a change in the second orientation or position, at 406. The method 400 further includes determining, by the processor, whether the second orientation or position is valid based on the signal, at 408. The method 400 further includes performing, by the processor, a response action responsive to determining that the second orientation or position is invalid due to the change of the first orientation or position of the first portal system platform, at 410.

In one implementation, the method 400 further includes determining, by the processor, a pre-determined blink rate (e.g., the blink rate 190) associated with the data 188, and the change in the first orientation or position 148 is determined based on a change in the pre-determined blink rate. In this example, the reference tag 196 corresponds to an active device. In some cases, use of an active device improves propagation distance of data transmitted by the reference tag.

In another implementation, the method 400 further includes determining, by the processor, a received signal strength (e.g., a received version of the signal strength 198) of the data 188, and the change in the first orientation or position 148 is determined based on a change in the received signal strength 198 of the data 188. In this example, the reference tag 196 corresponds to a passive device. In some cases, use of a passive device reduces (or avoids) power consumption of the reference tag. In some examples, the method 400 further includes monitoring the signal strength of the data 188 received by the portal system platform 104 from the reference tag 196 and adjusting the RFID interrogation signal strength transmitted toward reference tag 196 in order to maintain received signal strength of the data 188 within pre-set parameters.

In some implementations of the method 400, the change in the first orientation or position is determined based on an average received packet error rate that is based on a comparison of a first number of interrogation signals transmitted with a second number of data packets received by the portal system platform. For example, in one implementation, the processor 144 is configured to determine the change in first orientation or position 148 by determining the average received packet error rate 199 based on a comparison of the first number 183 of the RFID interrogation signals 181 transmitted by the portal system platform 104 and the second number 193 of the data packets 191 received by the portal system platform 104.

In another implementation, the method 400 further includes receiving sensor data (e.g., the sensor data 224) from the positioning sensor tag 204, and the change in the first orientation or position 148 is determined based on the sensor data 224. In a particular example, the positioning sensor tag 204 includes one or more of an accelerometer (e.g., the accelerometer 208), a tilt sensor (e.g., the tilt sensor 212), a compass (e.g., the compass 216), a pitch sensor (e.g., the pitch sensor 220), another electronic positioning sensor tag, or a combination thereof. In some implementations, use of the positioning sensor tag 204 increases accuracy of detection of movement of a portal system platform as compared to use of a reference tag 196. In one example, the first orientation or position 148 of the portal system platform 104 is determined in advance using the positioning sensor tag 204 to enable one or more LEDs of the optical alert device 164 to assist with an initial installation of the portal system platform 104, which can increase efficiency or accuracy of positioning of the portal system platform 104.

One or more aspects of the method 400 of FIG. 4A can be used to detect movement of one or more portal system platforms, such as the portal system platform 104. As a result, performance is improved by reducing or avoiding instances of misdetection of movement of wireless ID tags, such as the wireless ID tag 180.

Referring to FIG. 4B, a particular example of a method of operation of a processor is depicted and generally designated 450. In a particular implementation, the method 450 is performed by the processor 144.

The method 450 includes receiving, by a processor (e.g., the processor 144), detection data (e.g., the detection data 136) from a reader (e.g., the reader 124), at 452. The detection data is generated by the reader based on a wireless data signal (e.g., the wireless data signal 184) received from a wireless ID tag (e.g., the wireless ID tag 180).

The method 450 further includes determining, by the processor, that the wireless data signal has one or more characteristics distinct from all previous incoming information from the wireless ID tag 180, at 454. To illustrate, in one example, movement of the portal system platform 104 from the first orientation or position 148 to the second orientation or position 152 results in one or more changes in the wireless data signal 184 (as received by the portal system platform 104), such as a change in a blink rate 190 of the wireless data signal 184 as measured by the portal system platform 104, a change in a received signal strength of the wireless data signal 184, one or more other changes, or a combination thereof.

The method 450 further includes performing, by the processor, a response action based on a change of state of a portal system platform 104, at 456. Performing the response action includes generating an alert, a trap, or a notice to a system monitor. In one example, in response to detecting one or more changes in the wireless data signal, the processor 144 detects a change of state of the portal system platform 104 (e.g., by detecting movement of the portal system platform 104, such as movement from the first orientation or position 148 to the second orientation or position 152). In a particular example, in response to detecting the change of state of the portal system platform 104, the processor 144 is configured to generate an alert, a trap, or a notice to a system monitor, such as by generating the local alert 168, as an illustrative example.

One or more aspects of the method 450 of FIG. 4B can be used to detect movement of one or more portal system platforms, such as the portal system platform 104. As a result, performance is improved by reducing or avoiding instances of misdetection of movement of wireless ID tags, such as the wireless ID tag 180.

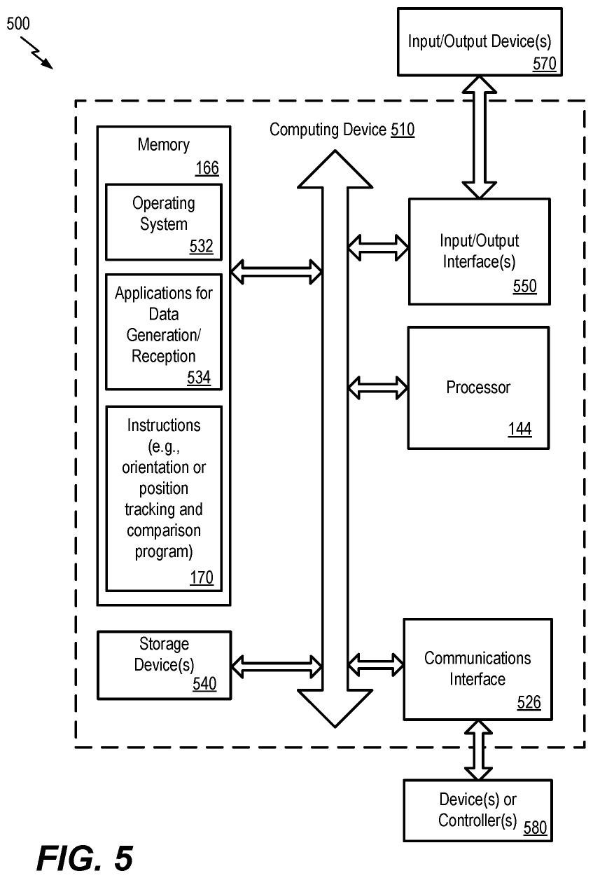

FIG. 5 is an illustration of a block diagram of a computing environment 500 including a computing device 510 configured to support embodiments of computer-implemented methods and computer-executable program instructions (or code) according to the disclosure. In some examples, the computing device 510, or portions thereof, executes instructions to initiate, perform, or control operations described herein, such as operations of the method 400 of FIG. 4A, operations of the method 450 of FIG. 4B, or both.

The computing device 510 includes the processor 144. The processor 144 is configured to communicate with the memory 166 (e.g., a system memory or another memory), one or more storage devices 540, one or more input/output interfaces 550, a communications interface 526, or a combination thereof.

Depending on the particular implementation, the memory 166 includes volatile memory devices (e.g., random access memory (RAM) devices), nonvolatile memory devices (e.g., read-only memory (ROM) devices, programmable read-only memory, or flash memory), one or more other memory devices, or a combination thereof. In FIG. 5, the memory 166 stores an operating system 532, which can include a basic input/output system for booting the computing device 510 as well as a full operating system to enable the computing device 510 to interact with users, other programs, and other devices. The particular example of FIG. 5 also depicts that the memory 166 stores one or more applications 534 executable by the processor 144. In some examples, the one or more applications 534 include instructions executable by the processor 144 to transmit signals between components of the computing device 510, such as the memory 166, the one or more storage devices 540, the one or more input/output interfaces 550, the communications interface 526, or a combination thereof.

The memory 166 is configured to store the instructions 170. In a particular example, the instructions 170 include an orientation or position tracking and comparison program, and the processor 144 is configured to execute the orientation or position tracking and comparison program to track orientation and position of the portal system platform 104 (or a component thereof) and to track orientation and position of wireless ID tags, such as the wireless ID tag 180. In a particular example, execution of the orientation or position tracking and comparison program causes the processor 144 to determine and store (e.g., to the memory 166) indications orientation and position of the portal system platform 104 (or a component thereof) and orientation and position of wireless ID, such as the wireless ID tag 180. In a particular example, execution of the orientation or position tracking and comparison program causes the processor 144 to detect changes in the orientation and position of the portal system platform 104 (or a component thereof) and orientation and position of wireless ID tags, such as the wireless ID tag 180.

In some implementations, one or more storage devices 540 include nonvolatile storage devices, such as magnetic disks, optical disks, or flash memory devices. In some examples, the one or more storage devices 540 include removable memory devices, non-removable memory devices or both. In some cases, the one or more storage devices 540 are configured to store an operating system, images of operating systems, applications, and program data. In a particular example, the memory 166, the one or more storage devices 540, or both, include tangible computer-readable media.

In the example of FIG. 5, the processor 144 is configured to communicate with the one or more input/output interfaces 550 to enable the computing device 510 to communicate with one or more input/output devices 570 to facilitate user interaction. In some implementations, the one or more input/output interfaces 550 include serial interfaces (e.g., universal serial bus (USB) interfaces or Institute of Electrical and Electronics Engineers (IEEE) 1394 interfaces), parallel interfaces, display adapters, audio adapters, one or more other interfaces, or a combination thereof. In some examples, the one or more input/output devices 570 include keyboards, pointing devices, displays, speakers, microphones, touch screens, one or more other devices, or a combination thereof. In some examples, the processor 144 is configured to detect interaction events based on user input received via the one or more input/output interfaces 550. Additionally, in some implementations, the processor 144 is configured to send a graphics data to a display device via the one or more input/output interfaces 550

In a particular example, the processor 144 is configured to communicate with (or send signals to) one or more devices 580 using the communications interface 526. In some implementations, the communications interface 526 includes one or more wired interfaces (e.g., Ethernet interfaces), one or more wireless interfaces that comply with an IEEE 802.11 communication protocol, one or more other wireless interfaces, one or more optical interfaces, or one or more other network interfaces, or a combination thereof. In some examples, the one or more devices 580 include host computers, servers, workstations, one or more other computing devices, or a combination thereof.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate, but do not limit, the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A system comprising:
a memory configured to store instructions; and
a processor coupled to the memory, wherein the processor is configured to:
determine, based on data received from one or more of a reference tag or a positioning sensor tag, a change in a first orientation or position of a portal system platform, wherein the portal system platform includes one or more antennas configured to receive a wireless data signal from a wireless identification (ID) tag and further includes a reader configured to output detection data based on the received wireless data signal;
determine, based on the detection data, a second orientation or position of the wireless ID tag or a change in the second orientation or position; and
determine whether the second orientation or position is valid based on the received data; and
perform a response action responsive to determining that the second orientation or position is invalid due to the change of the first orientation or position of the portal system platform.

2. The system of claim 1, wherein the reference tag is an active device.

3. The system of claim 2, wherein the reference tag includes a battery, and wherein the processor is further configured to determine the second orientation or position based on a change in a blink rate of the data or interruption of the data.

4. The system of claim 3, wherein the reference tag includes a wireless ID transmitter configured to transmit the data based on a pre-determined blink rate.

5. The system of claim 1, wherein the reference tag is a passive device.

6. The system of claim 5, wherein the processor is further configured to determine the change in the first orientation or position based on a change in received signal strength associated with the received data.

7. The system of claim 5, wherein the processor is further configured to determine the change in first orientation or position by determining an average received packet error rate that is based on a comparison of a first number of interrogation signals transmitted by the portal system platform with a second number of data packets received by the portal system platform.

8. The system of claim 5, wherein the reference tag includes a radio frequency identification (RFID) transmitter.

9. The system of claim 1, wherein the positioning sensor tag includes one or more of an accelerometer, a tilt sensor, a pitch sensor, a compass, another electronic positioning sensor, or a combination thereof.

10. A method of operation of a processor, the method comprising:
receiving, by a processor, detection data, the detection data generated by a portal system platform based on a wireless data signal received from a wireless identification (ID) tag, the portal system platform including one or more antennas to receive the wireless data signal and further including a reader to output the detection data based on the received wireless data signal;
determining, by the processor, a change in a first orientation or position of the portal system platform based on data received from one or more of a reference tag or a positioning sensor tag;
determining, by the processor and based on the detection data, a second orientation or position of a wireless ID tag or a change in the second orientation or position;
determining, by the processor, whether the second orientation or position is valid based on the received data; and
performing, by the processor, a response action responsive to determining that the second orientation or position is invalid due to the change of the first orientation or position of the portal system platform.

11. The method of claim 10, further comprising determining, by the processor, a blink rate associated with the data, wherein the change in the first orientation is determined based on a change in the blink rate.

12. The method of claim 10, further comprising determining, by the processor, a received signal strength of the data, wherein the change in the first orientation is determined based on a change in the received signal strength of the data.

13. The method of claim 10, wherein the change in the first orientation or position is determined based on an average received packet error rate that is based on a comparison of a first number of interrogation signals transmitted with a second number of data packets received by the portal system platform.

14. The method of claim 10, further comprising receiving sensor data from the positioning sensor, wherein the change in the first orientation is determined based on the sensor data.

15. The method of claim 14, wherein the positioning sensor includes one or more of an accelerometer, a tilt sensor, a pitch sensor, a compass, another electronic positioning sensor, or a combination thereof.

16. A computer-readable medium storing instructions executable by a processor to initiate, perform, or control operations, the operations comprising:
receiving, by a processor, detection data, the detection data generated by a portal system platform based on a wireless data signal received from a wireless identification (ID) tag, the portal system platform including one or more antennas to receive the wireless data signal and further including a reader to output the detection data based on the received wireless data signal;
determining, by the processor, a change in a first orientation or position of the portal system platform based on data received from one or more of a reference tag or a positioning sensor tag;
determining, by the processor and based on the detection data, a second orientation or position of a wireless ID tag or a change in the second orientation or position;
determining, by the processor, whether the second orientation or position is valid based on the received data; and
performing, by the processor, a response action responsive to determining that the second orientation or position is invalid due to the change of the first orientation or position of the portal system platform.

17. The computer-readable medium of claim 16, wherein the operations further include performing a data analytics operation to identify that a movement to the second orientation or position deviates from a tolerance range by more than a threshold.

18. The computer-readable medium of claim 16, wherein the operations further include generating a local alert indicating whether the second orientation or position is valid.

19. The computer-readable medium of claim 18, wherein the local alert is generated using an optical alert device.

20. The computer-readable medium of claim 19, wherein the first orientation or position of the portal system platform is determined using the positioning sensor tag to enable one or more light emitting diodes (LEDs) of the optical alert device to assist with an initial installation of the portal system platform.
